(19) United States
(12) Patent Application Publication
(10) Pub. No.: US 2025/0166647 A1
(43) Pub. Date: May 22, 2025

(54) Adaptive Codebook for Neural Network-Based Audio Codec

(71) Applicant: TENCENT AMERICA LLC, Palo Alto, CA (US)

(72) Inventors: Sheng LIN, Syracuse, NY (US); Xin ZHAO, San Jose, CA (US); Shan LIU, San Jose, CA (US)

(73) Assignee: TENCENT AMERICA LLC, Palo Alto, CA (US)

(21) Appl. No.: 18/902,309

(22) Filed: Sep. 30, 2024

Related U.S. Application Data
(60) Provisional application No. 63/601,162, filed on Nov. 20, 2023.
(60) Provisional application No. 63/604,259, filed on Nov. 30, 2023.

(51) Int. Cl. G10L 19/032; G10L 19/00

(52) U.S. Cl. CPC G10L 19/032; G10L 2019/0002

(57) ABSTRACT

This disclosure relates generally to audio coding and particularly to methods and systems for audio coding based on neural networks. In particular, feature vectors generated by a neural network audio encoder may be quantized using adaptive codebooks and/or grouped codebooks. Correspondingly, the encoded bitstream may be processed via a dequantization process using the adaptive codebooks and/or grouped codebooks. The adaptive codebooks or grouped code books may be selected to preserve a maximum bitrate and potentially increase coding efficiency

### INCORPORATION BY REFERENCE

This application is based on and claims the benefit of priority to U.S. Provisional Patent Application No. 63/601,162 filed on Nov. 20, 2023 and entitled “Adaptive Codebook for Neural Network-based Audio Codec,” and U.S. Provisional Patent Application No. 63/604,259 filed on Nov. 30, 2023 and entitled “Grouped Codebook for Neural Network-based Audio Codec,” which are herein incorporated by reference in their entireties.

### TECHNICAL FIELD

This disclosure relates generally to audio coding and particularly to methods and systems for audio coding based on neural networks.

### BACKGROUND

Audio coding has been widely used in many multimedia applications. There have been widely adopted audio coding standards/codecs such as Advanced Audio Coding (AAC), MP3, Opus, Free Lossless Audio Codec (FLAC), and Enhanced Voice Service (EVS) codec. An audio codec generally contains several modules or components, including transform coding, quantization, entropy coding, and psychoacoustic modeling, and the like. With the advent of deep learning, neural network-based audio codecs have also been developed which leverage the power of deep learning models to efficiently represent audio signals. Instead of manually designing each module or components of the codec, neural network-based codecs can be trained end-to-end.

### SUMMARY

This disclosure relates generally to audio coding and particularly to methods and systems for audio coding based on neural networks. In particular, feature vectors generated by a neural network audio encoder may be quantized using adaptive codebooks and/or grouped codebooks. Correspondingly, the encoded bitstream may be processed via a dequantization process using the adaptive codebooks and/or grouped codebooks. The adaptive codebooks or grouped code books may be selected to preserve a maximum bitrate and potentially increase coding efficiency.

In some example implementations, a method for encoding an audio segment is disclosed. The method may include generating a set of feature vectors by processing the audio segment using a pretrained neural-network audio encoder; and quantizing the set of feature vectors using at least one codebook to generate, for the set of feature vectors, a set of codebook indexes to feature vector entries in the at least one codebook as part of an encoded bitstream for the audio segment. The at least one codebook is adaptively selected and the adaptive selection is indicated in the encoded bitstream by explicit signaling or implicitly.

In the example implementations above, the at least one codebook comprises two or more adaptively selected codebooks, each of the two or more adaptively selected codebooks is used to quantize a different feature vectors of the set of the feature vectors of the audio segment.

In any one of the example implementations above, the set of feature vectors are split into N groups of feature vectors corresponding to N group indexes, N being a positive integer; the at least one codebook comprises N adaptively selected codebooks respectively corresponding to the N groups of feature vectors; and the set of codebook indexes for the set of feature vectors are generated within indexing spaces of corresponding N adaptively selected codebooks.

In any one of the example implementations above, sizes of each of the N adaptively selected codebooks are powers of 2.

In any one of the example implementations above, a total size of the N adaptively selected codebooks is bounded by a predefined upper limit.

In any one of the example implementations above, the N group indexes are determined by a relative encoding order of the N groups of feature vectors.

In any one of the example implementations above, the method may further include prior to quantizing the set of feature vectors, determining a quantization mode for the set of feature vectors as an adaptive codebook mode among at least two quantization modes comprising the adaptive codebook mode and a fixed codebook mode; and indicating the quantization mode for the set of feature vectors by an explicit signaling in the encoded bitstream or implicitly.

In any one of the example implementations above, the quantization mode for the set of feature vectors is implicitly derived coded information.

In any one of the example implementations above, the at least one codebook for quantizing the audio segment differs from codebooks adaptively selected for another audio segment.

In any one of the example implementations above, the at least one codebook is adaptively selected or updated based on reconstructed samples of another audio segment.

In any one of the example implementations above, quantization of audio segments associated with a same time duration for different channels share same codebooks.

In any one of the example implementations above, the at least one codebook is adaptively selected based on a type of the audio segment.

In any one of the example implementations above, the type of the audio segment is one of a music type, a speech type, and a general audio type, a mono audio type, and a stereo audio type.

In any one of the example implementations above, the type of the audio segment is explicitly signaled in the encoded bitstream or implicitly derivable.

Aspects of the disclosure also provide an electronic decoding device or apparatus or electronic encoding device or apparatus including a circuitry or processor configured to carry out any of the method implementations above.

Aspects of the disclosure also provide non-transitory computer-readable mediums storing instructions which when executed by an electronic device, cause the electronic device to perform any one of the method implementations above.

In some other example implementations, an electronic device comprising a memory for storing instructions and at least one processor is disclosed. The at least one processor is configured to execute the instructions to: receive an encoded bitstream of an audio segment; determine at least one codebook; decode from the encoded bitstream a set of codebook indexes to entries in the at least one codebook; generate from a set of feature vectors of the audio segment according to the at least one codebook and the set of codebook indexes; and process the set of feature vectors to generate a decoded audio segment using a neural-network audio decoder. The at least one codebook is adaptively selected based on explicit signaling or implicit derivation from the encoded bitstream.

In the example implementations above, the at least one codebook comprises N, the at least one codebook comprises N adaptively selected codebooks respectively corresponding to N groups of the set of feature vectors corresponding to N group indexes, N being a positive integer; and the set of codebook indexes are within indexing spaces of corresponding N adaptively selected codebooks.

In any one of the example implementations above, the at least one processor is configured to execute the instructions to: prior to determining the at least one codebook, determine a codebook mode for encoding the audio segment as an adaptive codebook mode among at least two codebook modes comprising the adaptive codebook mode and a fixed codebook mode by an explicit signaling in or implicit derivation from the encoded bitstream.

In any one of the example implementations above, the at least one codebook for the audio segment differs from codebooks adaptively selected for another audio segment.

In any one of the example implementations above, the at least one codebook is adaptively selected based on a type of the audio segment; the type of the audio segment is one of a music type, a speech type, and a general audio type, a mono audio type, and a stereo audio type; and the type of the audio segment is explicitly signaled in the encoded bitstream or implicitly derivable.

In some example implementations, the above electronic device may be configured to reverse the steps of any of the encoding methods and steps above.

Aspects of the disclosure also provide a decoding method including the decoding steps above carried out by the decoding electronic device.

Aspects of the disclosure also provide non-transitory computer-readable mediums storing instructions for implementing the encoding or decoding steps or methods above.

Aspects of the disclosure also provides audio bitstreams as generated using any of the encoding methods or electronic devices above.

### BRIEF DESCRIPTION OF THE DRAWINGS

Further features, the nature, and various advantages of the disclosed subject matter will be more apparent from the following detailed description and the accompanying drawings in which:

FIG. 1 shows a schematic illustration of a simplified block diagram of a communication system (100) in accordance with an example embodiment;

FIG. 2 shows a schematic illustration of a simplified block diagram of a communication system (200) in accordance with an example embodiment;

FIG. 3 shows an example end-to-end neural network-based audio codec architecture including both the encoding and decoding portions.

FIG. 4 shows an example quantization process of a quantizer that can be used in the encoding portion of the end-to-end neural network-based audio codec architecture of FIG. 3.

FIG. 4 shows an example quantization process of an example quantizer that can be used in the end-to-end neural network-based audio codec architecture of FIG. 3.

FIG. 5 shows an example dequantization process of an example dequantizer that can be used in the decoding portion of the end-to-end neural network-based audio codec architecture of FIG. 3.

FIG. 6 shows an example end-to-end neural network-based audio codec architecture including both the encoding and decoding portions and operative in various codebook mode including at least an adaptive codebook mode (e.g., a grouped codebook mode).

FIG. 7 shows an example adaptive-codebook-based quantization process of an example quantizer that can be used in the end-to-end neural network-based audio codec architecture of FIG. 6.

FIG. 8 shows an example adaptive-codebook-based dequantization process of an example dequantizer that can be used in the decoding portion of the end-to-end neural network-based audio codec architecture of FIG. 6.

FIG. 9 shows an example quantization process of an example quantizer based on grouped codebooks that can be used in the end-to-end neural network-based audio codec architecture of FIG. 6.

FIG. 10 shows an example dequantization process of an example dequantizer based on grouped codebooks that can be used in the decoding portion of the end-to-end neural network-based audio codec architecture of FIG. 6.

FIG. 11 shows an example logic and data flow for a method for end-to-end neural network-based audio encoding.

FIG. 12 shows an example logic and data flow for a method for end-to-end neural network-based audio decoding.

FIG. 13 shows a schematic illustration of a computer system in accordance with example embodiments of this disclosure.

### DETAILED DESCRIPTION OF EMBODIMENTS

Throughout the specification and claims, terms may have nuanced meanings suggested or implied in context beyond an explicitly stated meaning. The phrase “in one embodiment/implementation” or “in some embodiments/implementations” as used herein does not necessarily refer to the same embodiment/implementation and the phrase “in another embodiment/implementation” or “in other embodiments” as used herein does not necessarily refer to a different embodiment. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of context-dependent meanings. Typically, “or” if used to associate a list, such as A, B or C, is intended to mean A, B, and C, here used in the inclusive sense, as well as A, B or C, here used in the exclusive sense. In addition, the term “one or more”, “at least one”, “a”, “an”, or “the” as used herein, depending at least in part upon context, may be used in a singular sense or plural sense. In addition, the term “based on” or “determined by” may be understood as not necessarily intended to convey an exclusive set of factors and may, instead, allow for existence of additional factors not necessarily expressly described, again, depending at least in part on context.

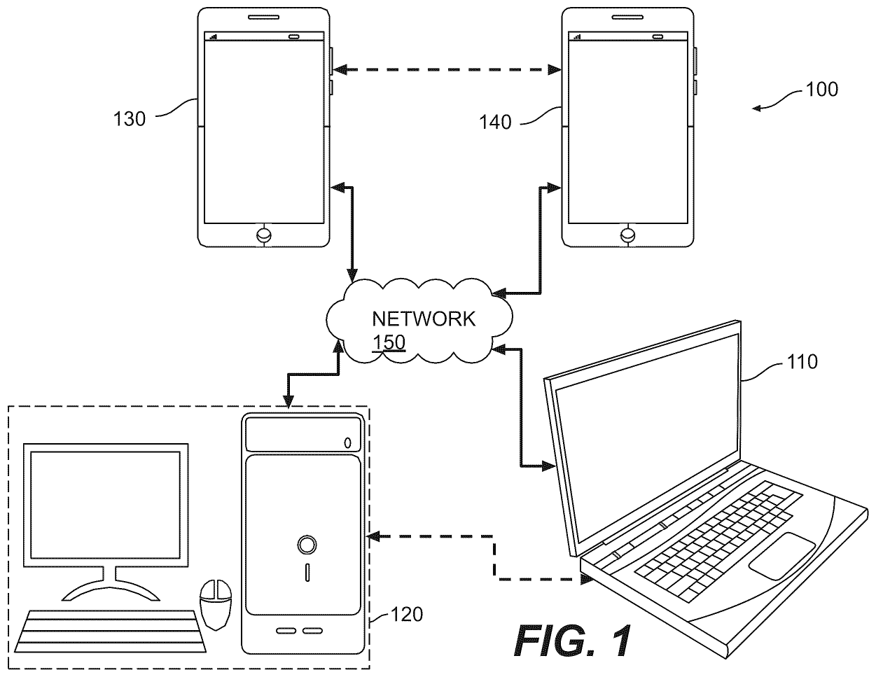

FIG. 1 illustrates a simplified block diagram of a communication system (100) according to an embodiment of the present disclosure. The communication system (100) includes a plurality of terminal devices, e.g., 110, 120, 130, and 140 that can communicate with each other, via, for example, a network (150). In the example of FIG. 1, the first pair of terminal devices (110) and (120) may perform unidirectional transmission of data. For example, the terminal device (110) may code multimedia data (including audio, video, other media data, or the combination thereof) in the form of one or more coded bitstreams (e.g., of a stream of multimedia data that are captured by the terminal device (110)) for transmission via the network (150). The encoded multimedia data can be transmitted in the form of one or more coded multimedia data bitstreams. The terminal device (120) may receive the coded multimedia data or image data from the network (150), decode the coded multimedia data to recover the original multimedia data and render the multimedia data according to the recovered multimedia data. Unidirectional data transmission may be implemented in media serving applications and the like.

In another example, the second pair of terminal devices (130) and (140) may perform bidirectional transmission of coded multimedia data, for example, during a videoconferencing application. For bidirectional transmission of data, in an example, each of the terminal devices (130) and (140) may code multimedia data (e.g., of a stream of audio/video data that are captured by the terminal device) for transmission to and may also receive coded multimedia data from another of the terminal devices (130) and (140) to the other terminal device of the terminal devices (130) and (140) via the network (150). Each terminal device of the terminal devices (130) and (140) also may receive the coded multimedia data transmitted by the other terminal device of the terminal devices (130) and (140), and may decode the coded multimedia data to recover the multimedia data and may render the multimedia data at an accessible rendering device (e.g., speaker device, display device) according to the recovered multimedia data.

In the example of FIG. 1, the terminal devices may be implemented as servers, personal computers and smart phones but the applicability of the underlying principles of the present disclosure may not be so limited. Embodiments of the present disclosure may be implemented in desktop computers, laptop computers, tablet computers, media players, wearable computers, dedicated video conferencing equipment, and/or the like. The network (150) represents any number or types of networks that convey coded video/image data among the terminal devices (110), (120), (130) and (140), including for example wireline (wired) and/or wireless communication networks. The communication network (150) may exchange data in circuit-switched, packet-switched, and/or other types of channels. Representative networks include telecommunications networks, local area networks, wide area networks and/or the Internet. For the purposes of the present discussion, the architecture and topology of the network (150) may be immaterial to the operation of the present disclosure unless explicitly explained herein.

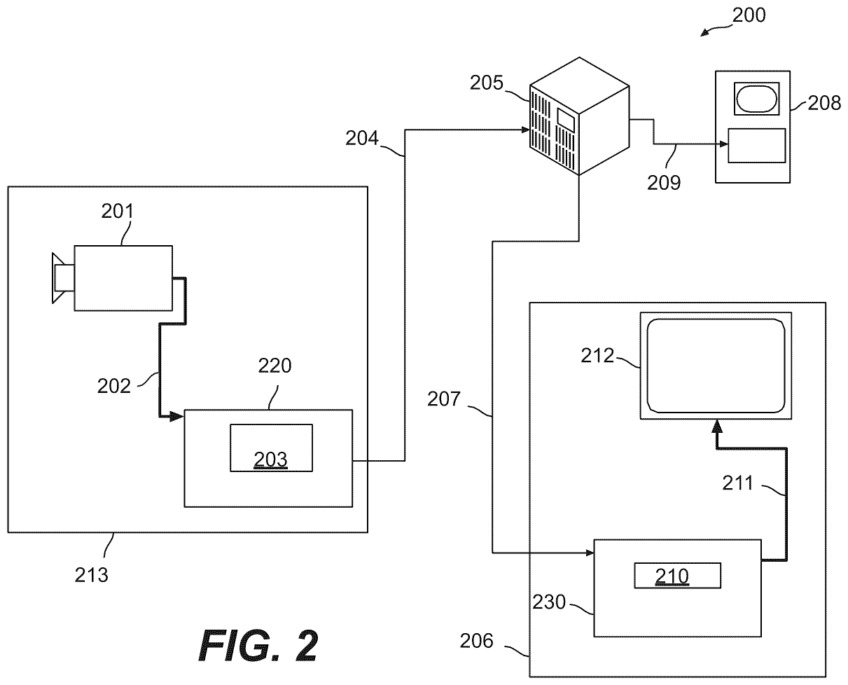

FIG. 2 illustrates, as an example for an application for the disclosed subject matter, a placement of a multimedia data encoder and a multimedia data decoder in a multimedia data streaming environment. The disclosed subject matter may be equally applicable to other multimedia applications, including, for example, video conferencing, digital TV broadcasting, gaming, virtual reality, storage of compressed audio/video/image on digital media including CD, DVD, memory stick and the like, and so on.

As shown in FIG. 2, a multimedia data streaming system may include a multimedia data capture subsystem (213) that can include a multimedia data source (201), e.g., a microphone, a digital camera, for creating a stream of multimedia data (202) that are uncompressed. In an example, the stream of multimedia data (202) includes samples that are recorded by a microphone for audio source and/or a digital camera for video/image source 201. The stream of multimedia data (202), depicted as a bold line to emphasize a high data volume when compared to encoded multimedia data (204) (or coded multimedia bitstreams), can be processed by an electronic device (220) that includes a multimedia data encoder (203) coupled to the multimedia data source (201). The multimedia data encoder (203) can include hardware, software, or a combination thereof to enable or implement aspects of the disclosed subject matter as described in more detail below. The encoded multimedia data (204) (or encoded multimedia bitstream (204)), depicted as a thin line to emphasize a lower data volume when compared to the stream of uncompressed multimedia data (202), can be stored on a streaming server (205) for future use or directly to downstream multimedia devices (not shown). One or more streaming client subsystems, such as client subsystems (206) and (208) in FIG. 2 can access the streaming server (205) to retrieve copies (207) and (209) of the encoded multimedia data (204). A client subsystem (206) can include a multimedia data decoder (210), for example, in an electronic device (230). The multimedia data decoder (210) decodes the incoming copy (207) of the encoded multimedia data and creates an outgoing stream of multimedia data (211) that are uncompressed and that can be rendered on a display (212) (e.g., a display screen) or other rendering devices (not depicted) or a speaker system for audio. The multimedia data decoder 210 may be configured to perform some or all of the various functions described in this disclosure. In some streaming systems, the encoded multimedia data (204), (207), and (209) (e.g., audio/video/image bitstreams) can be encoded according to certain multimedia data coding/compression standards.

It is noted that the electronic devices (220) and (230) can include other components (not shown). For example, the electronic device (220) can include a multimedia data decoder (not shown) and the electronic device (230) can include a multimedia data encoder (not shown) as well.

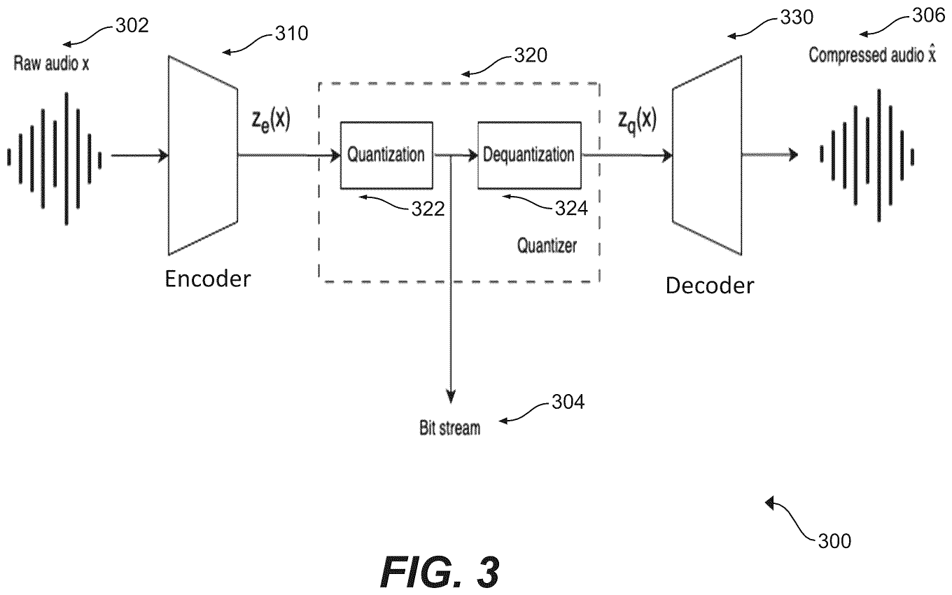

The disclosure below focuses on audio encoding and decoding methods and devices, and particularly concerns end-to-end neural network-based (NN-based) audio codecs. Such an end-to-end NN-based audio codec architecture 300, for example, may include three main components: an encoder 310, a quantizer 320, and a decoder 330, as illustrated in FIG. 3. The quantizer 320 may further include a quantization component 322 and a dequantization component 324. The encoder 310 and the quantization component 322 may form the encoding portion of the end-to-end NN-based audio codec architecture 300, whereas the quantization component 324 and the decoder 330 may form the decoding portion of the end-to-end NN-based audio codec architecture 300.

The encoder 310 may take the raw audio signal 302 as input and processes it through one or more neural networks to create a more compact floating-point representation of the input raw audio signal. The quantizer 320 encompasses both the quantization and dequantization components or modules 322 and 324, enabling a conversion between discrete and continuous signal representations. As shown in FIG. 3, a bitstream 304 of the input audio may be generated after the quantization component 322 to represent compressed audio. The decoder 330 may also include one or more neural networks and may receive the bitstream 304, taking the dequantized representation and processing it through the neural networks of the decoder 330 to reproduce/recover reconstructed samples of the compressed audio.

As described above for the example end-to-end neural network-based audio codec 300, both the encoder 310 and decoder 330 may utilize neural networks. The architecture of each of such neural network may include multiple convolutional layers, activation functions, and several normalization layers, and the like. The encoder 310 and decoder 330 may include significant amount of trained model parameters and dominate in terms of computation complexity and storage demands within the entire codec 300. The term neural network model, as used in this disclosure, refers to the neural network structure, or model parameters or hyper parameters used in the neural network structure.

The input audio signal 302 may be segmented for processing by the audio codec 300. The window length (in time) for the segmentation of the input audio signal may play a pivotal role in determining the granularity at which the audio signal is processed and encoded, and in affecting encoding/decoding delays for real-time communication applications. In some example implementations, window lengths may range from 20 milliseconds to 30 milliseconds, although this can vary based on the specific codec and application. Such example window lengths may be chosen to strike a balance between temporal resolution and frequency resolution. In the context of audio codecs, the smallest time unit of input may be referred to as a segment. Segments of the input audio signal may be encoded independently or with dependencies therebetween.

The role of the encoder 310 may include converting segments of raw input audio signal 302 (referred to as “x”) into feature vectors Zₑ(x) using its trained neural networks. The role of the quantizer 322 may include converting the feature vectors of the audio segment as generated by the encoder 310 into a bitstream 304 using one or more codebooks. Each of the one or more codebooks may include indexed entries of predefined codewords of feature vectors. The quantization component 322 may then determine, for each feature vector from the encoder 310 a best approximating codeword in a selected codebook and output a corresponding codebook index for inclusion as part of the bitstream 304. The design and selection of codebooks for the quantization component 322 thus critically affect a balance between the coding efficiency and coding loss/fidelity.

In some example implementations for codebook design in a quantization component of a NN-based audio code, a residual vector quantizer (RVQ) may be employed as an advanced form of vector quantization for efficiently encoding information. The RVQ may be designed to overcome some of the limitations of basic vector quantization by providing higher quality reconstruction with lower bit rates. In RVQ, for example, after the initial quantization step, a residual (difference between the original feature vector and the dequantized feature vector that would be obtained after the dequantization component) is calculated. The residual is then quantized and dequantized again using a second codebook or a second set of codebooks. This process can be repeated multiple times with multiple codebooks (or multiple sets of codebooks). In each iteration (or step), the residual generated as the difference between the original feature vector and the dequantized feature vector from the previous iteration, after that, the residual is further quantized using a specific quantization codebook and fed into the next iteration of quantization.

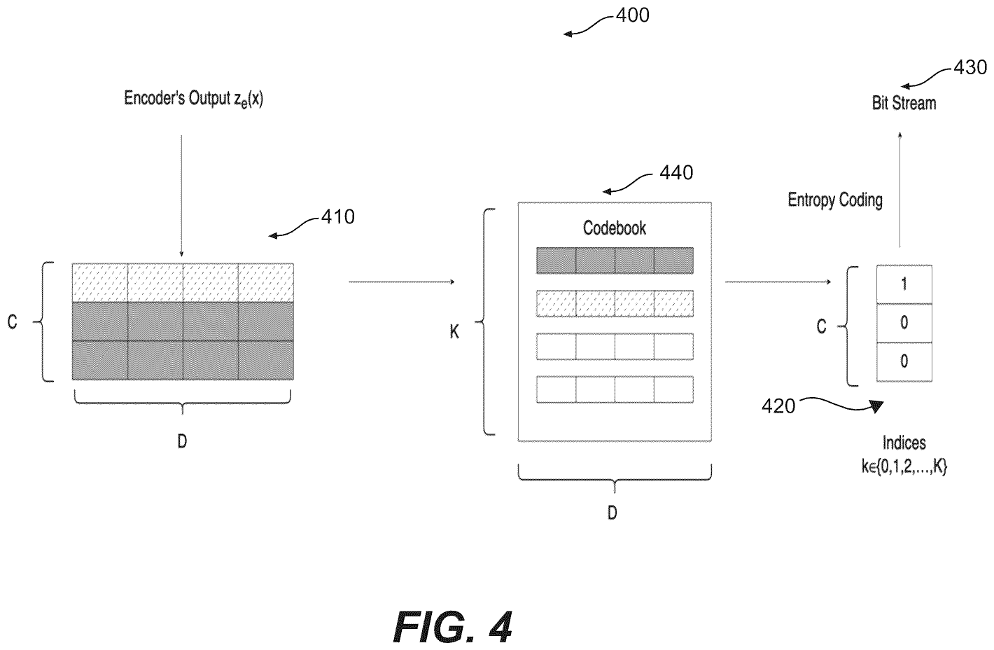

As shown in an example encoding process 400 of FIG. 4 in the end-to-end NN-based architecture using fixed-size codebook, the input audio segment x may be first encoded by the encoder 310 to generate high-level representation feature vectors zₑ(x), where zₑ( ) represents operations conducted by the neural network of the encoder and zₑ(x) is usually a 3D tensor with shaped in three dimensions of [B, C, D]. “B” represents batch size. “C” represents channel dimension indicating a number of feature vectors (number of channels) for a batch among B batches of the audio segment, and the “D” is for dimension_of_feature and represents the number of vector components of a feature vector. Example feature vectors of a batch as output zₑ(x) of the encoder is illustrated as 410 of FIG. 4, showing C channels of feature vectors having D vector components in each feature vector. The encoder's output zₑ(x) may be fed to the quantization component 322 to perform quantization to generate C codebook indices 420 for the C feature vectors based on a codebook 440, which may be further entropy coded to generate part of the bitstream 430. The codebook may be of size K, and each of the K entries in the code book corresponds to a codebook feature vector codeword of dimension D. Given the codebook 440, for each encoder's output feature vector, the nearest neighbor within the codebook is selected (as described in further detail below) and the index of the selected entry corresponding to the nearest neighbor within the codebook 440 becomes part of the indices output 420.

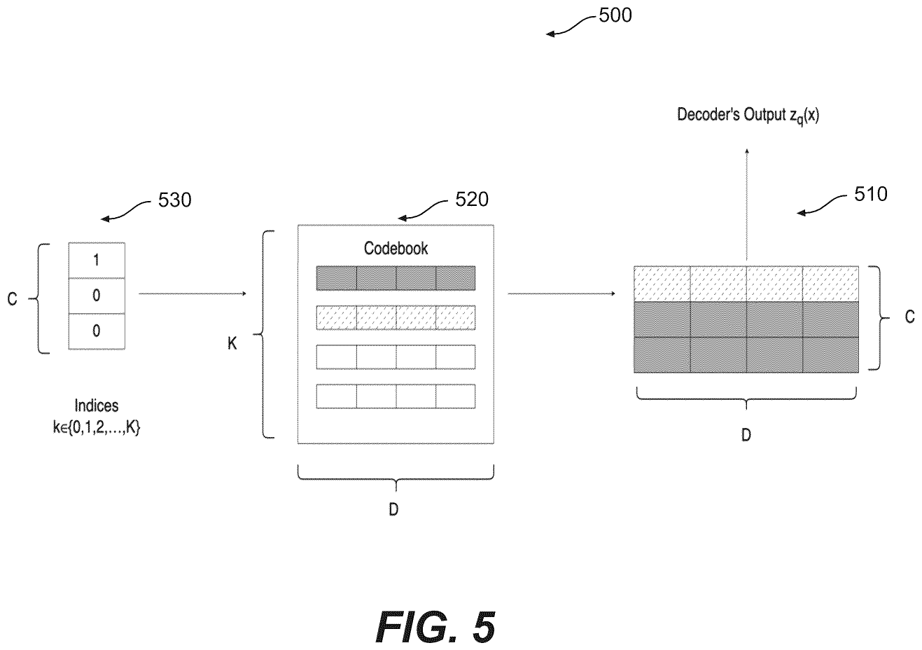

As further shown in an example decoding process 500 of FIG. 5, the dequantization component 324 may be used to generate high-level feature vector representation z_{q}(x) 510 from entropy decoded indices 530, where z_{q}( ) represents the operations conducted by codebook 520 and z_{q}(x) may also a 3D tensor with the same shape as zₑ(x) of FIG. 4. Given the codebook 520 and the entropy decoded indices 530, corresponding feature vector codewords in the codebook 520 may be extracted and identified to generate z_{q}(x), which may then be further processed by neural networks fo the decoder 330 to generate audio signals of the audio segment.

In the example implementations above, an audio segment refers to a group of audio samples that are 3D tensor, which may be shaped in three dimensions of [B, C, S], where S represents number of audio samples.

In this disclosure, an output matrix of an encoder or an input matrix of a decoder refers to a floating-point matrix which is one batch from the zₑ(x) tensor or the z_{q}(x) tensor above. The shape of such a matrix is of two dimensions [C, D], as shown by 410 of FIG. 4 and 510 of FIG. 5. Further in this disclosure, an output vector of the encoder or input vector of the decoder refers to a floating-point vector from the output matrix of the encoder or the input matrix of the decoder, and such a vector is of a single dimension D, as shown by the row vectors in 410 of FIG. 4 and 510 of FIG. 5.

In some example implementations, for encoding based on the codebook and to find the nearest neighbor in the codebook for an input vector, the codebook encoding process may involve first calculating a distance between the input vector and each of the vectors or codewords in the codebook. An ArgMin operation, for example, may then be applied to the array of distances to determine the index of the closest vector or codeword in the codebook to the input vector as identified by the lowest distance. This is indicated by the shading of various vectors in FIG. 4. For example, out of the example K feature vectors in the codebook 440, the second entry with index 1 has the smallest distance with the first row vector of the input matrix 410, the first entry in the codebook with index 0 has the smallest distance with the second row vector of the input matrix 410, and the first entry in the codebook with index 0 has the smallest distance with the third row vector of the input matrix 410. Consequently, the output indices 420 for the input matrix containing the three row feature vectors would be (1, 0, 0).

Conversely, the entropy decoded indices 530 in FIG. 5 may be used for feature vector or codewords lookup in the codebook entries in the codebook 520. The reconstruction of the floating-point feature vector is provided to the neural networks of the decoder for further processing in order to generate the audio signal.

As shown above in the implementations of FIG. 4 and FIG. 5, the encoder's output matrix may use the same codebook to process in comparison the codebook of for the encoding processing. The output matrix is shaped as [C, D], where, again, C stands for number of feature and D stands for the dimension of each feature vector. The codebook feature dimension size D is usually the same as the encoder's size of each output channel (each feature vector), or the encoder's output is otherwise projected to fit the size of D. The codebook size K defines index length or the size of the indexing space, and this size is usually a power of 2, such as 1024 (index space with 10 bits), 512 (9-bit index space), etc. The codebook is thus a K×D matrix, representing K codewords entries, each codeword with D components.

In some example implementations, a codebook used by the quantization component may be kept at a fixed size throughout each iteration of quantization and dequantization or even between audio segments. However, a feature vector (e.g., each vector of zₑ(x) and an intermediate quantized vector in the quantization and dequantization iterations) may represent different characteristics of the input audio signal and therefore associated with different importance to the reconstruction quality of the coded bitstream, using fixed size codebook may not differentiate the importance among different feature vectors and may introduce less efficient rate allocation among different feature vectors. As such, in some other example implementations, a quantizer may be configured to use adaptive or grouped codebooks, as will be described in further detail below. For example, the codebook in terms of size and codewords content may vary within an audio segment, between segment, between audio channels, and/or between quantization/dequantization iterations. For another example, without changing the overall bitrate, or with a similar target bitrate, a group of codebooks may be utilized to enhance codebook encoding/decoding efficiency in each quantization/dequantization step, as described further below. The description below, while focusing on a particular quantization or dequantization iteration, or without mentioning a particular iteration but concerning general quantization of dequantization, is applicable to any iteration.

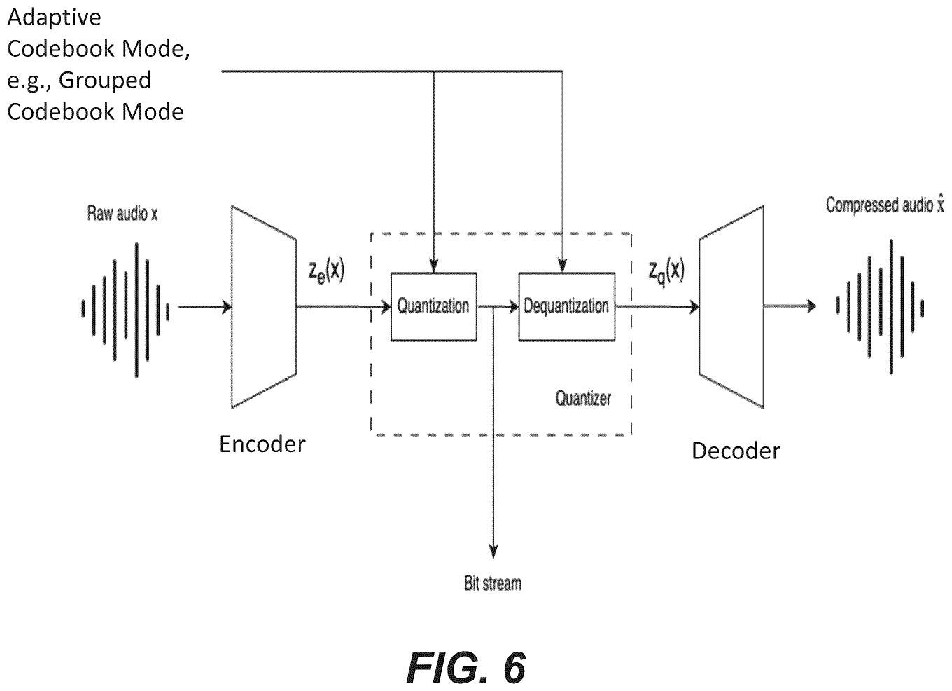

An example design of adaptive codebook implementation for neural network-based audio codec is shown in FIG. 6, where, in comparison to FIG. 3, the codebook used by the quantization component and the dequantization component of the quantizer may be made adaptive. Such an implementation may provide improvement on the implementations involving NN-based audio codec with fixed-size codebook by designing an adaptive codebook mode to modify the settings of the quantizer. Different codebook configurations may be adopted for different codebook modes (or, for simplicity, modes).

In an adaptive codebook mode, different codebooks may be applied for quantizing and dequantizing different features or feature vectors in an NN-based audio codec.

In some example implementations, either one or more fixed codebooks that are the same for all features, or one or more adaptive codebooks applied for quantizing and dequantizing different features, can be used. A selection between fixed codebook and adaptive codebook can be determined during the encoding process and may either be signaled or implicitly derived from the encoded bitstream.

In one example, the selection between fixed codebook(s) and adaptive codebook(s) may be signaled in high-level syntax, including but not limited to, a flag for each segment of the audio samples, or a flag for the entire audio sequence, and the like.

In another example, the selection between fixed codebook(s) and adaptive codebook(s) for a current audio segment may be implicitly derived based on coded information that is available for both encoder and decoder, including but not limited to the codebook(s) used for the previous audio segment, the reconstructed samples, or a coded syntax in the bitstream.

In some example implementations, part of the feature vectors may be coded using the same codebook and part of the feature vectors may be coded using different codebooks. In other words, the codebooks can switch from feature vector to feature vector, either by switching between the fixed codebook mode or adaptive code mode, or switching between different codebooks within the adaptive codebook mode.

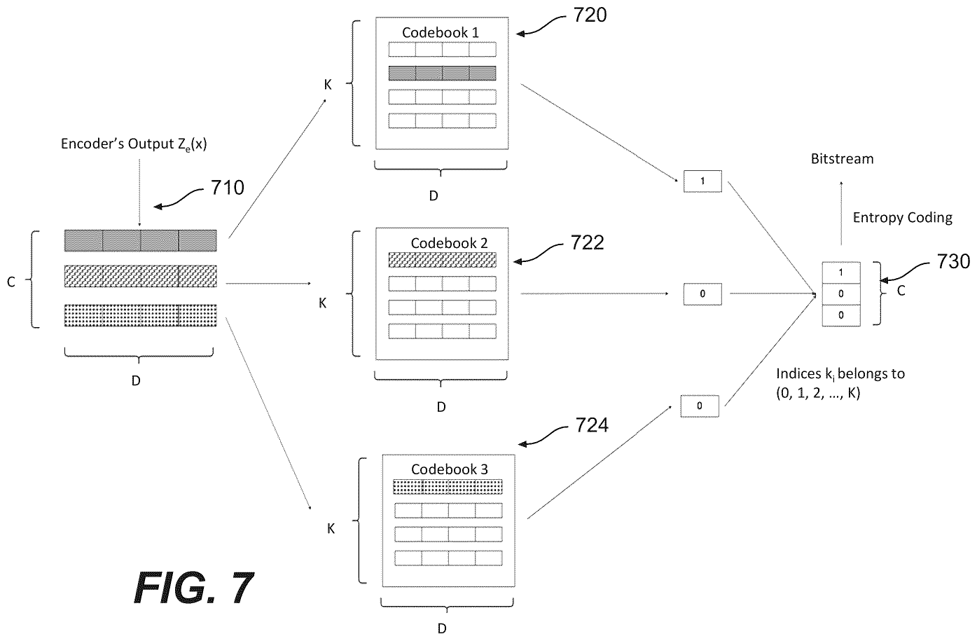

In some example implementations, for encoding, each of the C feature vectors may be associated with a defined codebook. As show in FIG. 7, in the quantization process, there may be C feature vectors 710 with a channel size D in an audio batch. Each feature vector may use a different K×D sized codebook to find its best index. The example codebooks corresponding to the 3 example feature vectors in FIG. 7 includes coodbook 1, coodbook 2, and coodbook 3, labeled respectively as 720, 722, and 724. The C indices in 730 are thus relative to these different codebooks rather than a same codebook. In the example of FIG. 7, the second entry of codebook 1, the first entry of codebook 2, and the first entry of codebook 3 may be the closest in distance to the first, second, and third feature vectors in 710, respectively, hence the C indices are (1, 0, 0). These C indices are then combined for entropy coding.

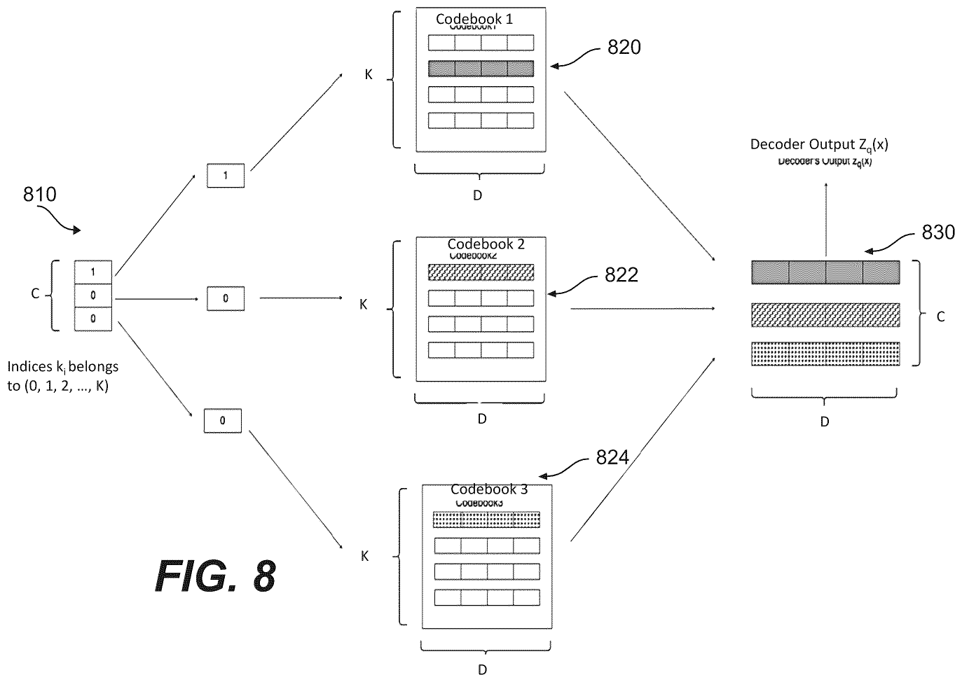

In some corresponding example implementations, for decoding, as shown in FIG. 8, the C quantization indices 810 are received for the C feature vectors, and then in the dequantization process, for each of the C indices, a codebook is first determined (different codebooks, indicated as 820, 822, and 824 for codebook 1, codebook 2, and codebook 3, respectively) may be used for different feature vectors). Then the associated index is used to fetch the codeword which is the dequantized feature vector in the corresponding codebook. In the example of FIG. 8, the indices (1, 0, 0) means fetching the second entry of codebook 1, fetching the first entry of codebook 2, and fetching the first entry of codebook 3. Then the dequantized feature vectors 830 fetched from the different codebooks are fed into the decoder to perform decoding using a neural network structure, as described above.

In some other example implementations, feature vectors, e.g., in a batch of an audio segment, may be categorized into different groups, and each group of feature vectors may be associated with one codebook. As such, different groups of feature vectors may be associated with different codebooks, and the feature vectors in each of the groups may be associated with the same codebooks. In comparison to the examples of FIGS. 7 and 8, these example implementations provide feature group-based codebooks rather than feature-based codebooks. A group of feature vectors may include one or more feature vectors. A group of features may include one feature vector, or it may include multiple feature vectors. The codebooks used in such implementations for NN-based audio codec may be referred to as grouped codebooks.

Such implementations may provide an improvement by designing a group of different codebook sizes in the settings of the quantizer, and the codebook size may depend on the associated feature vectors. The codebook size may be designed to maintain a bitrate. For example, as shown in FIGS. 4 and 5, codebook size for the fixed-codebook approach may be K (which determines the bit depth of the indices), and the number of feature vectors may be C. Therefore, the minimum bitrate unit is decided by C*K. For the approach based on grouped codebooks, the feature vectors may be split into N group and different quantization codebooks may be applied for different groups. In some example implementations, a constraint, i.e., C*K=Σᵢ₌₁^{i=N}Ci*Ki (where Cᵢ represents the number of feature vectors in the ith group and Kᵢ represents the size of the codebook or the number of codewords for the ith group) may be applied, so that the overall compression ratio may not change from the fixed codebook implementations.

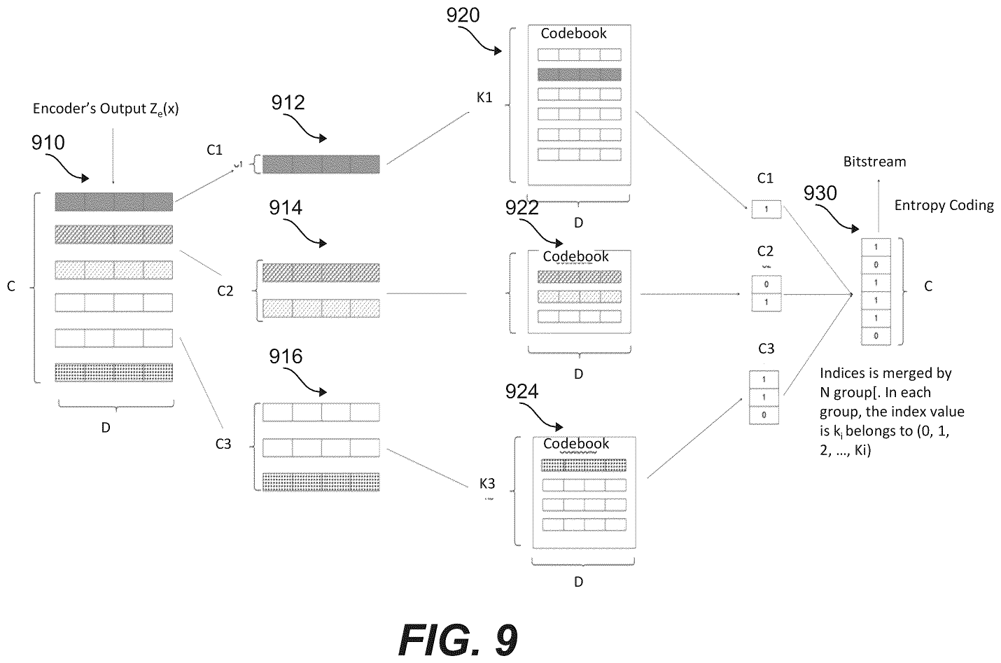

Such example implementations, from an encoding standpoint, is illustrated in FIG. 9, wherein the C feature vectors 910 with channel size D (e.g., of a batch of an audio segment) may be divided into N=3 groups, 912, 914, and 914, containing 1, 2, and 3 feature vectors, respectively, as an example. In the quantization process, the groups 912, 914, and 916 of feature vectors respectively having C1=1, C2=2, and C3=3 feature vectors, where C1+C2+C3=C, are associated with different codebooks 920, 922, and 924, with sizes K1, K2, and K3, respective. The indices for vectors in each of the groups are generated with respect to the corresponding codebook before the indices are aggregated into the C indices 930, where the first index is for the one feature vector in the first group 912, the second and third indices are for the two feature vectors in the second group 914, and the fourth through sixth indices are for the three feature vectors in the third group 916. The identification of an index for a feature vector is similar to above process for identifying an entry in the corresponding group codebooks with the least distance to the feature vector. The bits needed to represent the quantized index for a feature vector in a group indexed by i is log2(Ki). Once all indices are calculated, then they are combined for further entropy coding.

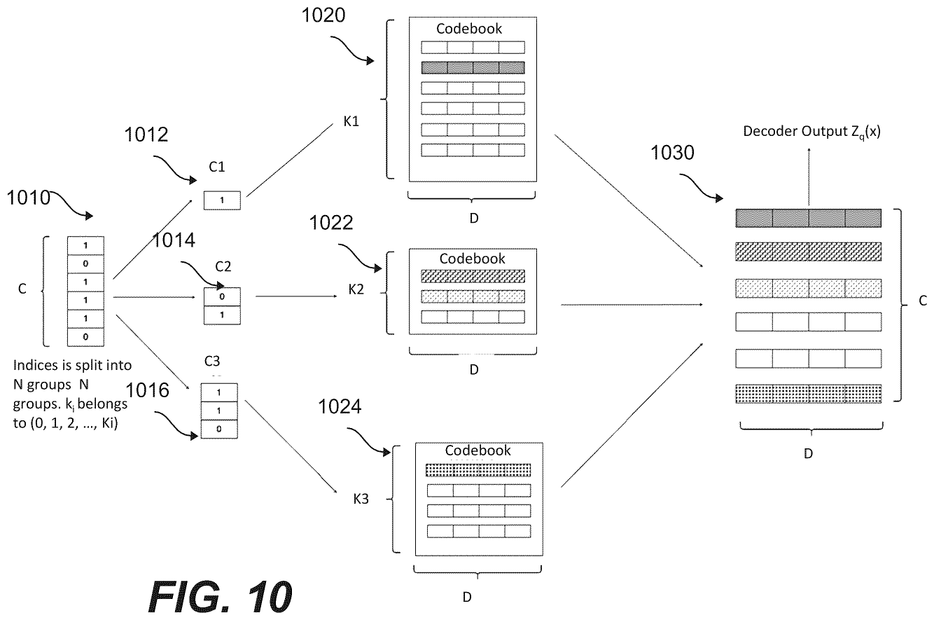

Such group codebook implementations from the decoding standpoint are shown in FIG. 10, where the C quantization indices 1010 are received for the C feature vectors. In the dequantization process, these indices are split into N group (e.g., 3 groups 1012, 1014 and 1016) with Cᵢ indexes for group i (i represents the group index, and Σᵢ₌₁^{i=N}Ci=C, and in the example of FIGS. 10, C₁=1, C₂=2, and C₃=3), and for each group of the Cᵢ indices, a codebook with size Kᵢ×D is determined, as shown by the three example group codebooks 1020, 1022, and 1024. Then the associated indices are used to fetch the codewords from the group codebooks which are the dequantized feature vectors. After the dequantized feature vectors are calculated in each group, the combined dequantized feature vectors 1030 are fed into the decoder to perform decoding using a neural network structure.

In some example implementations, the group index above for a quantization index in, for example, 930 and 1010, may be determined by the relative decoding order among all the quantization indices.

In some example implementations, the number of codewords associated with each group i, i.e., Kᵢ, may be a power of 2.

In some example implementations, the classification of groups between encoder and decoder are matched with each other, e.g., the group index i for a quantization index may be determined by the relative coding (encoding or decoding) order among all the quantization indices.

In some example implementations, the codebook associated for the same group index is the same between encoder and decoder.

Again, such grouped codebook implementations may be provided as one of the codebook modes. For example, either a fixed codebook mode that use a same size for codebook for all features, or grouped codebook mode, which applies different codebooks with different codebook sizes for quantizing and dequantizing different features, may be provided as configurable or selectable options, as shown in FIG. 6. In some implementations, three modes may be provided as an option, e.g., the fixed codebook mode, the general adaptable codebook mode above, and the grouped codebook mode. In some other implementations, the grouped codebook mode may be considered a submode of the adaptive codebook mode.

In some example implementations, the selection between fixed codebook and grouped codebook can be either signaled in or implicitly derived from the encoded bitstream.

In one example, the selection between fixed codebook(s) and grouped codebook(s) may be signaled in high-level syntax, including but not limited to, a flag for each segment of the audio samples, or a flag for the entire audio sequence, and the like.

In another example, the selection between fixed codebook(s) and grouped codebook(s) for a current audio segment may be implicitly derived based on coded information that is available for both encoder and decoder, including but not limited to the codebook(s) used for the previous audio segment, the reconstructed samples, or a coded syntax in the bitstream.

In some examples of the adaptive codebook implementations above, different codebooks may be applied or selected for quantizing and dequantizing different segments in an audio sequence. In some example of the adaptive codebook implementations above, different codebooks may be applied or selected between quantization and dequantization steps, e.g., iterative quantization and dequantization steps above.

In some examples of the adaptive codebook implementations above, an initial segment of the audio sequence may use a set of codebooks, and subsequent segments may use a different set of codebooks.

In some examples of the adaptive codebook implementations above, the codebook(s) can be adaptively adjusted during the encoding and decoding. For example, such adjustment on the codebook may be performed based on the reconstructed samples of another segment. In another example, the adjustment on the codebook may be performed based on syntaxes signaled in the bitstream from the decoding side. Such syntaxes may be generated by the encoding process and included in the bitstream.

In some example implementations, for audio with multiple audio channels, a segment associated with a same time slot for different audio channels may share the same codebook(s). Alternatively, for audio with multiple audio channels, a segment associated with a same time slot for different channels may use different codebooks. In other words, the adaptivity may be applied between segments of same time from different audio channels.

In some examples of the adaptive codebook implementations above, different codebooks may be applied or selected for quantizing and dequantizing different types of audio sequence/segment in each quantization and dequantization step. Adaptive codebook encoding/decoding may be provided with multiple modes and configured as multiple options. The options may include different manners of adaptivity described above. The selections of the modes and options can either be signaled by a flag in the bitstream or derived implicitly from the information in the bitstream.

In some example implementations, the type of audio sequence above may be either explicitly signaled or implicitly derived. The type of audio sequence may be one of a music type, a speech type, a general audio type, a mono audio type, a stereo audio type, merely as examples. In some example implementations, the music type audio sequences may use a set of codebooks, speech type audio sequences may use a different set of codebooks, and a general audio sequence may use yet another different set of codebooks. In some example implementations, a mono audio (single channel) sequence may use a set of codebooks, whereas a stereo audio (multiple channels) sequence may use a different set of codebooks.

In some example implementations, the said flag above for adaptive modes may be signaled at different level of time granularity. In one example, such a signal may be enabled at segment level. In another example, such a signal may be enabled at sequence level.

In some example implementations, the flag above is conditionally signaled. The condition, for example, may depends on any coded information that is known to both encoder and decoder. In some example implementations, the flag above may be inherited from a value of a same flag from a previous segment.

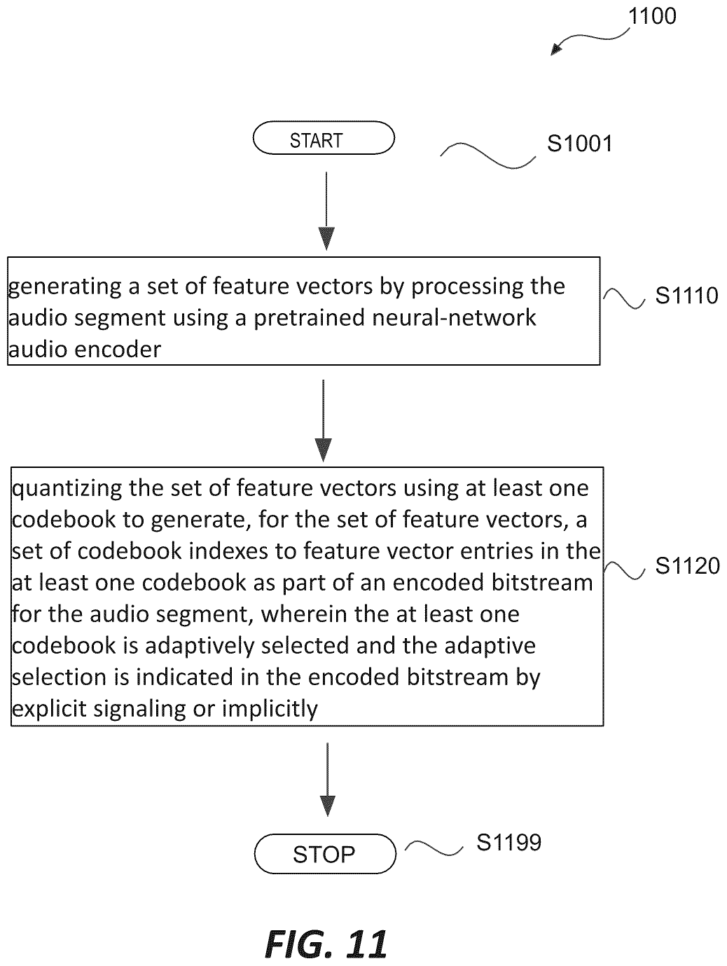

FIG. 11 illustrates an example logic and data flow 1100 according the implementations above. The logic and data flow is performed for encoding an audio segment. The logic flow 1100 starts at S1101. In S1110, a set of feature vectors are generated by processing the audio segment using a pretrained neural-network audio encoder. In S1120, the set of feature vectors are quantized using at least one codebook to generate, for the set of feature vectors, a set of codebook indexes to feature vector entries in the at least one codebook as part of an encoded bitstream for the audio segment. The at least one codebook is adaptively selected and the adaptive selection is indicated in the encoded bitstream by explicit signaling or implicitly. The logic flow 1100 stops at S1199.

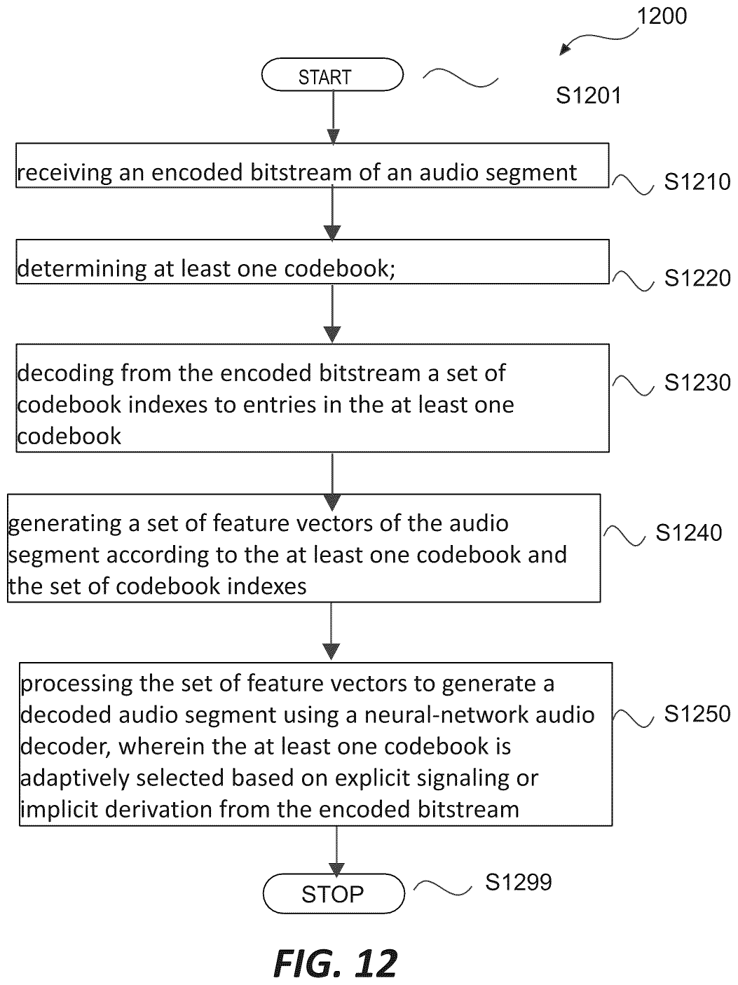

FIG. 12 illustrates another example logic and data flow 1200 according the implementations above. The logic and data flow is performed for decoding an audio segment. The logic flow 1200 starts at S1201. In S1210, an encoded bitstream of an audio segment is received. In S1220, at least one codebook is determined. In S1230, a set of codebook indexes to entries in the at least one codebook are decoded from the encoded bitstream. In S1240, a set of feature vectors of the audio segment are generated according to the at least one codebook and the set of codebook indexes. In S1250, the set of feature vectors are processed to generate a decoded audio segment using a neural-network audio decoder. The at least one codebook is adaptively selected based on explicit signaling or implicit derivation from the encoded bitstream The logic flow 1200 stops at S1299.

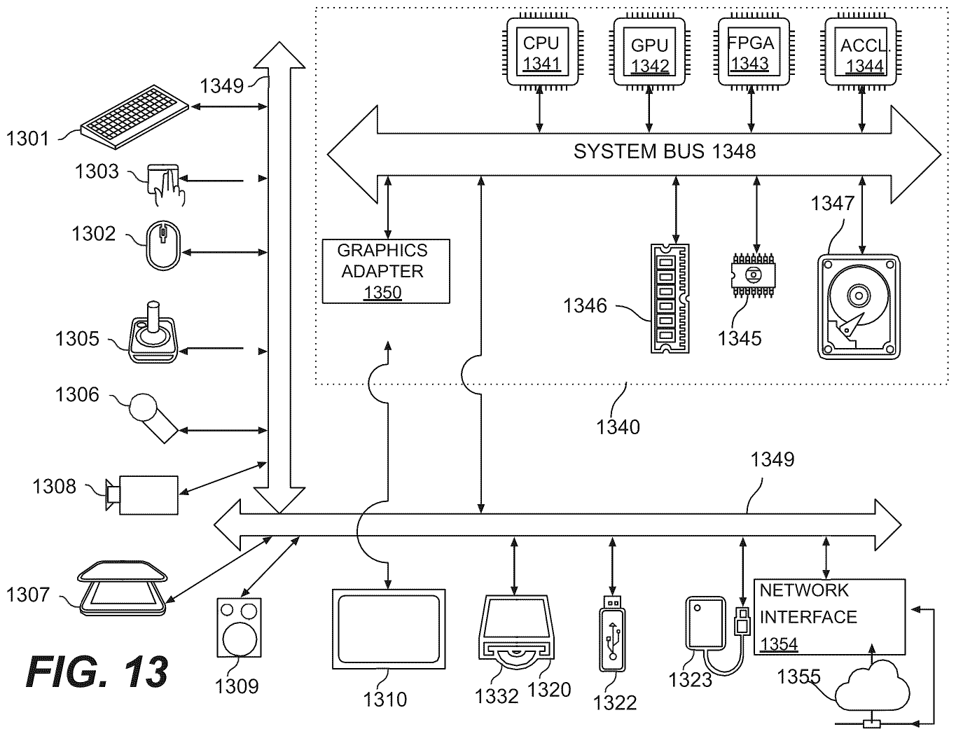

The techniques described above, can be implemented as computer software using computer-readable instructions and physically stored in one or more computer-readable media. For example, FIG. 13 shows a computer system (1300) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 13 for computer system (1300) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1300).

Computer system (1300) may include certain human interface input devices. Input human interface devices may include one or more of (only one of each depicted): keyboard (1301), mouse (1302), trackpad (1303), touch screen (1310), data-glove (not shown), joystick (1305), microphone (1306), scanner (1307), camera (1308).

Computer system (1300) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1310), data-glove (not shown), or joystick (1305), but there can also be tactile feedback devices that do not serve as input devices), audio output devices (such as: speakers (1309), headphones (not depicted)), visual output devices (such as screens (1310) to include CRT screens, LCD screens, plasma screens, OLED screens, each with or without touch-screen input capability, each with or without tactile feedback capability-some of which may be capable to output two dimensional visual output or more than three dimensional output through means such as stercographic output; virtual-reality glasses (not depicted), holographic displays and smoke tanks (not depicted)), and printers (not depicted).

Computer system (1300) can also include human accessible storage devices and their associated media such as optical media including CD/DVD ROM/RW (1320) with CD/DVD or the like media (1321), thumb-drive (1322), removable hard drive or solid state drive (1323), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1300) can also include an interface (1354) to one or more communication networks (1355). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CAN bus, and so forth.

Aforementioned human interface devices, human-accessible storage devices, and network interfaces can be attached to a core (1340) of the computer system (1300).

The core (1340) can include one or more Central Processing Units (CPU) (1341), Graphics Processing Units (GPU) (1342), specialized programmable processing units in the form of Field Programmable Gate Arcas (FPGA) (1343), hardware accelerators for certain tasks (1344), graphics adapters (1350), and so forth. These devices, along with Read-only memory (ROM) (1345), Random-access memory (1346), internal mass storage such as internal non-user accessible hard drives, SSDs, and the like (1347), may be connected through a system bus (1348). In some computer systems, the system bus (1348) can be accessible in the form of one or more physical plugs to enable extensions by additional CPUs, GPU, and the like. The peripheral devices can be attached either directly to the core's system bus (1348), or through a peripheral bus (1349). In an example, the screen (1310) can be connected to the graphics adapter (1350). Architectures for a peripheral bus include PCI, USB, and the like.

The computer readable media can have computer code thereon for performing various computer-implemented operations. The media and computer code can be those specially designed and constructed for the purposes of the present disclosure, or they can be of the kind well known and available to those having skill in the computer software arts.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for encoding an audio segment, comprising:
generating a set of feature vectors by processing the audio segment using a pretrained neural-network audio encoder; and
quantizing the set of feature vectors using at least one codebook to generate, for the set of feature vectors, a set of codebook indexes to feature vector entries in the at least one codebook as part of an encoded bitstream for the audio segment,
wherein the at least one codebook is adaptively selected and the adaptive selection is indicated in the encoded bitstream by explicit signaling or implicitly.

2. The method of claim 1, wherein the at least one codebook comprises two or more adaptively selected codebooks, each of the two or more adaptively selected codebooks is used to quantize a different feature vectors of the set of the feature vectors of the audio segment.

3. The method of claim 1, wherein:
the set of feature vectors are split into N groups of feature vectors corresponding to N group indexes, N being a positive integer;
the at least one codebook comprises N adaptively selected codebooks respectively corresponding to the N groups of feature vectors; and
the set of codebook indexes for the set of feature vectors are generated within indexing spaces of corresponding N adaptively selected codebooks.

4. The method of claim 3, wherein sizes of each of the N adaptively selected codebooks are powers of 2.

5. The method of claim 3, where a total size of the N adaptively selected codebooks is bounded by a predefined upper limit.

6. The method of claim 3, wherein the N group indexes are determined by a relative encoding order of the N groups of feature vectors.

7. The method of claim 1, further comprising:
prior to quantizing the set of feature vectors, determining a quantization mode for the set of feature vectors as an adaptive codebook mode among at least two quantization modes comprising the adaptive codebook mode and a fixed codebook mode; and
indicating the quantization mode for the set of feature vectors by an explicit signaling in the encoded bitstream or implicitly.

8. The method of claim 7, wherein the quantization mode for the set of feature vectors is implicitly derived coded information.

9. The method of claim 1, wherein the at least one codebook for quantizing the audio segment differs from codebooks adaptively selected for another audio segment.

10. The method of claim 1, wherein the at least one codebook is adaptively selected or updated based on reconstructed samples of another audio segment.

11. The method of claim 1, wherein quantization of audio segments associated with a same time duration for different channels share same codebooks.

12. The method of claim 1, wherein the at least one codebook is adaptively selected based on a type of the audio segment.

13. The method of claim 12, wherein the type of the audio segment is one of a music type, a speech type, and a general audio type, a mono audio type, and a stereo audio type.

14. The method of claim 12, wherein the type of the audio segment is explicitly signaled in the encoded bitstream or implicitly derivable.

15. An electronic device comprising a memory for storing instructions and at least one processor configured to execute the instructions to:
receive an encoded bitstream of an audio segment;
determine at least one codebook;
decode from the encoded bitstream a set of codebook indexes to entries in the at least one codebook;
generate a set of feature vectors of the audio segment according to the at least one codebook and the set of codebook indexes; and
process the set of feature vectors to generate a decoded audio segment using a neural-network audio decoder,
wherein the at least one codebook is adaptively selected based on explicit signaling or implicit derivation from the encoded bitstream.

16. The electronic device of claim 15, wherein:
the at least one codebook comprises N
the at least one codebook comprises N adaptively selected codebooks respectively corresponding to N groups of the set of feature vectors corresponding to N group indexes, N being a positive integer; and
the set of codebook indexes are within indexing spaces of corresponding N adaptively selected codebooks.

17. The electronic device of claim 15, the at least one processor is configured to execute the instructions to:
prior to determining the at least one codebook, determine a codebook mode for encoding the audio segment as an adaptive codebook mode among at least two codebook modes comprising the adaptive codebook mode and a fixed codebook mode by an explicit signaling in or implicit derivation from the encoded bitstream.

18. The electronic device of claim 15, wherein the at least one codebook for the audio segment differs from codebooks adaptively selected for another audio segment.

19. The electronic device of claim 15, wherein:
the at least one codebook is adaptively selected based on a type of the audio segment;
the type of the audio segment is one of a music type, a speech type, and a general audio type, a mono audio type, and a stereo audio type; and
the type of the audio segment is explicitly signaled in the encoded bitstream or implicitly derivable.

20. A method for processing an audio segment, comprising converting the audio segment to an encoded audio bitstream, wherein the encoded audio bitstream comprises:
an indication that the audio segment is encoded based on N adaptively selected codebooks each containing entries of audio feature vectors, N being a positive integer; and
N groups of encoded indexes corresponding to the N adaptively selected codebooks, the N groups of encoded indexes being associated with a set of feature vectors of the audio segment.
